(19) United States
(12) Patent Application Publication
(10) Pub. No.: US 2013/0278399 A1
(43) Pub. Date: Oct. 24, 2013

(54) RESPONDING TO HEALTHCARE ALERTS

(71) Applicant: 3M INNOVATIVE PROPERTIES COMPANY, ST. PAUL, MN (US)

(72) Inventors: Steven B. Graniewitz, Ramat Gan (IL); Nachum Shmilovitz, ST. PAUL (IL); Avi Ben-Hayun, Rinatia (IL)

(73) Assignee: 3M INNOVATIVE PROPERTIES COMPANY, ST. PAUL, MN (US)

(21) Appl. No.: 13/833,471

(22) Filed: Mar. 15, 2013

Related U.S. Application Data
(60) Provisional application No. 61/636,876, filed on Apr. 23, 2012.

(51) Int. Cl. G06K 7/10

(52) U.S. Cl. CPC G06K 7/10366
USPC 340/286.06

(57) ABSTRACT

A healthcare alert system including a plurality of alert modules, each alert module including an activation component and an RFID reader. The RFID readers in the alert modules are configured to read identification information of a responder to an alert from an RFID tag associated with the responder, and to transmit the identification information to a central system. The central system is configured associate a time stamp with the identification information and to process the identification information and time of response. In one embodiment, the activation component is a pull cord.

### TECHNICAL FIELD

The present disclosure relates to a radio frequency identification (RFID) healthcare alert system, including, in some embodiments, a pull cord.

### BACKGROUND

The healthcare field currently provides a variety of ways for patients, assisted living home residents, and other individuals living in a group setting or by themselves to request assistance. An individual may request assistance or trigger an alert or alarm for a multitude of reasons. Examples include if an individual has fallen, is in need of assistance performing a task, or needs food, water, or some other item. In some situations, residents may have a device worn around their neck, a device mounted somewhere in their room, or a device on their bed that allows them to indicate a need for assistance by activating the device. When the individual activates the device, notification of the alert or alarm may be indicated by illuminating a light on the device, a light outside their room, or activate lights on devices or locations in tandem. Additionally, the alert may be directly sent to a central system to indicate a need for assistance. An individual designated to respond will often provide the assistance requested after receiving notice of the alert.

While there are currently systems that allow individuals to indicate a need for assistance and may potentially alert other individuals who can respond to that need, advancements in the field of healthcare monitoring and responder monitoring would be welcomed.

### SUMMARY

Current systems that provide a method of notification for individuals who respond to healthcare related alerts (also called responders) do not track the time between activation of an alert and a responder's response to the request. In environments like nursing homes or assisted living homes, understanding how long it takes a responder to respond to an alert can be important for demonstrating quality of care provided to a resident and understanding responsiveness of multiple responders who may respond to an alert.

Further, tracking the length of time a responder requires to respond to an alert can be useful in understanding whether a resident or user requires more regular assistance or a different model of care. Tracking the length of time a responder requires to respond to an alert can also be useful in providing insight regarding the current or future medical condition of an individual. An increased length of time required to respond to an alert, recurring alerts or alarms, or a noticeable incremental pattern in time increase can imply that the condition of an individual is deteriorating and their current care plan may require immediate alteration.

Generally, current systems are unable to accurately determine or document who responds to an alert or alarm. By monitoring who acknowledges and responds to an alert or alarm, healthcare environments such as nursing or assisted living homes are able to improve accountability awareness, document efficiencies, and adequately manage staffing resources to best meet the needs of the facility and regulated standards. Healthcare environment staff may be held accountable for proper or improper responses to alerts or alarms and appropriate action can be taken to commend or reprimand their behavior.

Meeting or exceeding the expectations of regulated standards can be a requirement to accredit healthcare environments. Recordation and management of alert or alarm response time and responder identification provides an accurate and continual source of benchmarking information to assist with maintaining accreditation status. Collected information may also be mined for educational or training purposes. Current or future healthcare environment staff can use the data to proactively construct care strategies for incoming patients and residents.

To solve the problems and provide the advantages discussed, the present disclosure is set forth.

In one embodiment, the present disclosure includes a radio frequency identification (RFID) healthcare alert module. The healthcare alert module includes at least an activation component and an RFID reader. A user can activate an alert using the activation component. The RFID reader is configured to read identification information of a responder from an RFID tag associated with the responder, and to transmit the identification information to a central system.

In a second embodiment, the present disclosure includes an RFID healthcare alert system. The RFID healthcare alert system includes at least a plurality of alert modules, and each alert module comprises an activation component and an RFID reader. At least one of the RFID readers is configured to read identification information of a responder from an RFID tag associated with the responder, and to transmit the identification information to a central system. The central system is configured to associate a time stamp with the received identification information.

In a third embodiment, the present disclosure discusses a method of handling a healthcare alert. The method includes receiving an activation of an alert module through an activation component. The method further includes generating an alarm corresponding to the activation of the alert module, and reading identification information from an RFID tag associated with at least one responder using an RFID reader. The method then includes transmitting the identification information to a central system.

### BRIEF DESCRIPTION OF DRAWINGS

For a more complete understanding of the present disclosure and its advantages, reference is now made to the following description, taken in conjunction with the accompanying drawings, in which:

FIG. 1 shows an exemplary healthcare alert module in a user's room.

FIG. 2 shows an exemplary healthcare alert module.

FIG. 3 shows an exemplary responder tag including an RFID tag.

FIG. 4 shows a system diagram of an exemplary healthcare alert system.

FIG. 5 shows a flow chart showing an exemplary workflow associated with a healthcare alert module.

While like numbers refer to like features in various figures, the use of like numbers is not intended to be limiting, but rather to increase clarity for the reader.

### DETAILED DESCRIPTION

The present disclosure provides significant advantages over the existing art. For example, the present disclosure enables a residential healthcare facility to understand who responded to a healthcare alert and the time it took for a responder to arrive at the location of the healthcare alert module. It also enables tracking of the time required for the responder to respond to the alert, measured by the time between the responder's arrival and departure from the healthcare alert module. Access and analysis of responder arrival time, duration of alarm response, and identification information made available through the present disclosure enhances healthcare facility staff accountability, educational opportunities, and accreditation metrics.

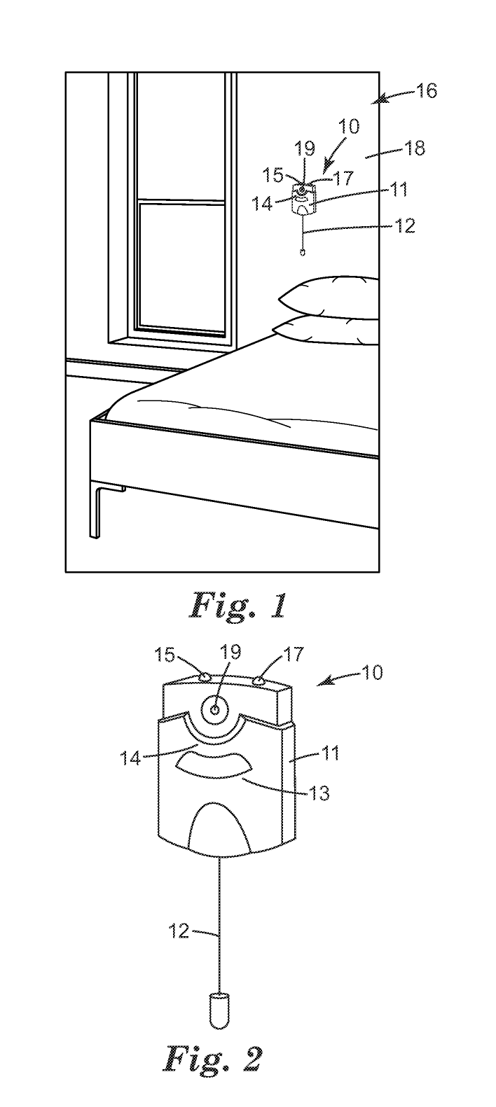

FIG. 1 shows an exemplary healthcare alert module 10 in a user's room 16. While the healthcare alert module shown here is in a user's bedroom 16, it may be located in a variety of places, such as in a bathroom, at a door or door frame, in a shared living space or at any other helpful location. While the healthcare alert module 10 is shown as mounted to a stationary object, wall 18, it may also be portable. A portable healthcare alert module 10 may be mounted to a wheelchair, movable bed, or even be worn by a user. The healthcare alert module 10 includes several components, and many of them may be contained within housing 11, attached to it or exterior to it. For example, activation component 12, illustrated as a pull cord, is mounted interior of housing 11 and hangs freely from healthcare alert module 10. A user can activate an alert by using activation component 12. In this configuration, activation component 12 can be used such that an alert is activated by pulling the pull cord. In some embodiments, healthcare alert module 10 may include a light emitting diode (LED) 19 which is illuminated upon activation of an alert, and which provides a visual indication that assistance is required.

Healthcare alert module 10 includes a radio frequency identification (RFID) reader 14, in many configurations, enclosed within housing 11. RFID reader 14 can interrogate an RFID tag associated with a particular responder or a group of responders. RFID reader 14 includes an antenna that generates and transmits a strong high frequency (HF) electromagnetic field at a given frequency, for example, 13.56 MHz. The field generated by the antenna of RFID reader 14 passively penetrates the antenna of the RFID tag tuned to the same frequency via transformer type inductive coupling resonating and receiving a signal containing information stored on the RFID tag. Information may include an identification number for the tag, identification information for a responder associated with the tag, and/or any other appropriate information.

Healthcare alert module 10 may also include, in some configurations, a reset mechanism such as reset button 15. A responder to an alert generated by the healthcare alert module 10 can reset the healthcare alert module 10 by pressing reset button 15. Reset button 15 may be pressed when a responder arrives at the location of the healthcare alert module 10, or upon completion of any task or required assistance that prompted a user to activate an alert. Pressing reset button 15 clears the alert from the healthcare alert module 10. In some embodiments, a reset mechanism may also cause an activation component 12 to be mechanically reset. Reset button 15 may be used to clear an open alert in a central system, as discussed in further detail below.

Healthcare alert module 10 may also include a presence mechanism such as presence button 17. Presence button 17 can provide an important function in situations where an individual requires low levels of care. To confirm that the individual is present in a particular location and not in need of assistance, an individual may be required to press presence button 17 at regular intervals, such as once per day.

FIG. 2 shows a drawing of an exemplary healthcare alert module 10. Healthcare alert module 10 includes housing 11, activation component 12, module processor 13, RFID reader 14, reset button 15, presence button 17 and LED 19. While FIG. 2 shows a particular shape for healthcare alert module 10 that can be easily wall-mounted, it can be any practical physical shape, such that it could be mounted to another stationary object, such as a door or door frame, or to a portable object, or it may be a stand-alone item to be carried or worn.

Activation component 12 may be any variety of mechanisms or sensors, whether mechanical, electrical or otherwise. For example, activation component 12 may be a button, switch, lever, or other mechanism. In one embodiment, activation component 12 may include a cord with a button or other mechanism, which an individual could press or otherwise trigger, attached to it. This would allow an individual with limited mobility to have easy access to activate an alert. Activation component 12 could be configured as an electrical sensor for proximity, presence, or even certain movements, such as a sensor for determining that a user wearing healthcare alert module 10 has fallen, and activating an alarm based on the fall. Activation component 12 may be a touch screen, where a user chooses a particular selection offered by the screen based on the user's particular need. Other configurations for activation component 12 will be apparent to one of ordinary skill in the art upon reading the present disclosure.

RFID reader 14 typically includes a power source and an antenna tuned to generate an electromagnetic field at a given frequency. Many high frequency RFID readers are configured to operate at about 13.56 MHz. Ultra-high frequency readers, such as those in the 300 to 3000 MHz range may also be used consistent with the present disclosure. The general principles of operation using an ultra-high frequency (UHF) reader would be similar to HF readers except the principles of backscatter technology would be used to obtain information from an RFID tag. Read ranges of UHF readers are greater than those achieved by HF readers and modification of the procedure would be necessary to verify who acknowledged and addressed an alert when it was activated. Other electromagnetic sensor technologies such as infrared sensors may be used to identify a particular responder to an activated alert. Examples of RFID readers that could be incorporated into a healthcare alert module are TRF796 HF Reader made by Texas Instruments Incorporated, of Dallas, Tex.; the 2100 Library HF Reader made by 3M Company of St. Paul, Minn.; or the ALR-9900 UHF Reader made by Alien Technology Corporation headquartered in Morgan Hill, Calif. An example of an infrared sensor is the NaPiOn (AMN) made by Panasonic Corporation.

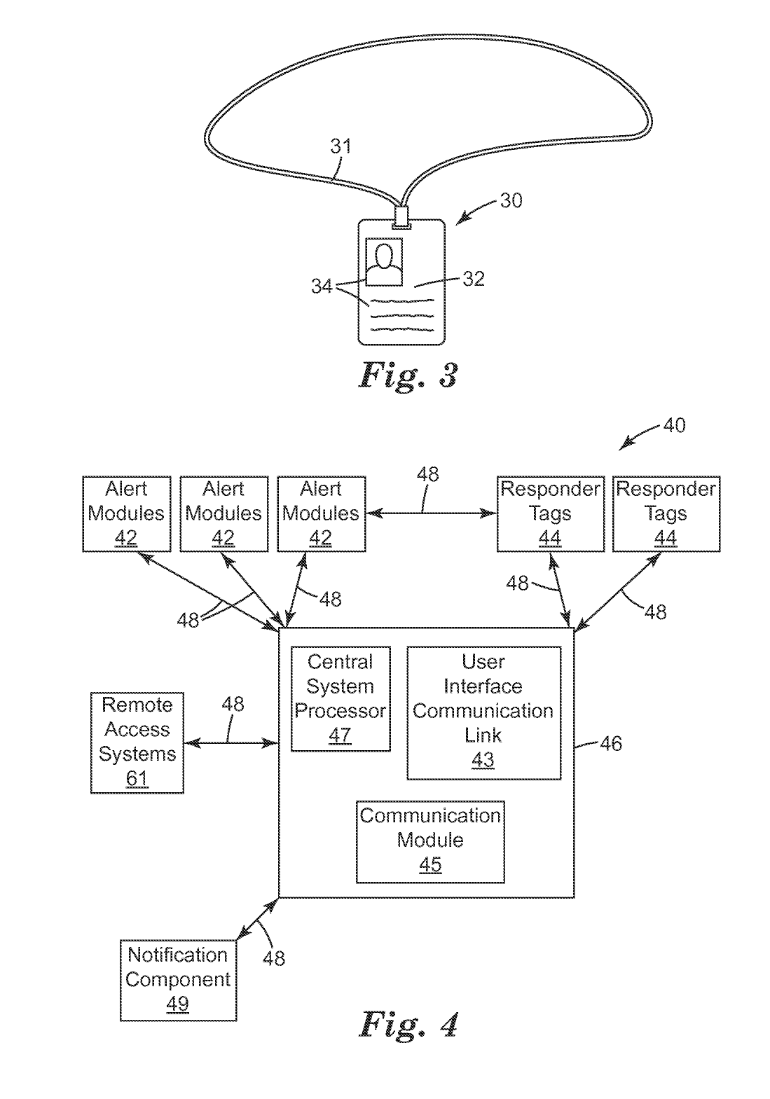

In some configurations, RFID reader 14 may also be configured to write information to RFID tags. For example, RFID reader 14 may write information to an RFID tag 32 in a responder tag 30 as described in further detail in FIG. 3. For example, RFID reader 14 may be controlled by a central system or otherwise used to write initial identification or configuration information to the RFID tag in responder tag 32. This can reduce the pieces of RFID equipment required, thereby reducing overall system cost.

Reset button 15 is an example of a reset mechanism, and may be a press button as shown in FIG. 2, or may be any other appropriate mechanism, including a switch, lever, sensor, other electrical component, or may even be incorporated as a feature on a touch screen. A reset mechanism can be configured so that it can only be activated by an authorized responder. Additionally, healthcare alert module 10 may be configured so that the activation component 12 is automatically reset after a predetermined time-out period.

Processor 13 controls the various electronic components in healthcare alert module 10 as appropriate. For example, processor 13 can interface with activation component 12, RFID reader 14 and reset button 15. Processor 13 can interface with a central system as a hardwired component or through a wireless communication protocol. Techniques of the present disclosure may be implemented on a general-purpose microprocessor, application specific integrated circuit (ASIC), field programmable gate array (FPGA), digital signal processor (DSP) or other processors and would be apparent to one of skill in the art. The processor also consists of a computer-readable storage medium that may comprise random access memory (RAM), synchronous dynamic random access memory (SDRAM), non-volatile random access memory, electrically erasable programmable read-only memory (EEPROM), FLASH memory or other magnetic or optical storage media.

An exemplary healthcare alert module 10 consistent with the present disclosure may include more or fewer components to simplify the design or add additional functionality. Additionally, the components discussed above may be combined in a large variety of combinations within the scope of the present disclosure, which will be apparent to one of skill in the art.

FIG. 3 shows an exemplary responder tag 30 incorporating an RFID tag 32. Responder tag 30 may be a traditional identification tag associated with a particular employee, nurse, assistant, or other individual assigned or expected to respond to alerts generated by healthcare alert module 10. Responder tag 30 may be worn on a lanyard 31 or otherwise carried or worn by a responder. It may include readable responder identification information 34, such as a photograph, name, employee number, employer information etc. Responder tag 30 may also include a power source, integrated circuit (IC), and a radio frequency (RF) interface that communicates with a central system. The interface may actively transmit and receive information with the central system via an HF or UHF signal. Information stored on the IC and transferred through the RF interface may include an identification number for the responder. It may also include identification information for the particular alert module 10 transmitting the information. An RFID tag 32 may be incorporated into the interior of responder tag 30 or may be attached to a responder tag 30. RFID tag 32 typically includes an antenna and an integrated circuit (IC) chip. The antenna is tuned to a particular frequency such that it transmits data stored on the IC chip in response to an electromagnetic field at the same or a similar frequency to which the antenna is tuned. The IC chip may store a variety of information, such as an identification number, information associated with the responder, verification and authenticity information or any other desired information. Information associated with a particular identification number can also be stored on the central system and accessed when the identification number from RFID tag 32 is read and recognized.

While RFID tag 32 is described as passive above, it may be an active tag, such that it has its own power source and can actively transmit information without relying on energy in exterior electromagnetic fields.

In some configurations, responder tag 30 may also have a responder alert mechanism 35. A responder alert mechanism may be an LED, liquid crystal display (LCD) or other device that can notify responder of an alert without the responder having to refer to any additional devices. The responder alert mechanism 35 may be configured to display a room number or other information to identify the location a responder would need to go to for responding to the alert.

In some configurations, responder tag 30 may include both passive and active RF capabilities. In such a configuration, a passive RFID tag 32 may be used for communication with an alert module as described throughout, while active RF capabilities are used for generally tracking the location of the responder using a network of regional hubs capable of detecting proximate location of the responder based on a signal transmitted by active RF component.

FIG. 4 shows a system diagram of an exemplary healthcare alert system 40. A healthcare alert system 40 may include a variety of modular and configurable components. Central system 46 can be configured to interact with all other components in healthcare alert system 40 through communication module 45, such as alert modules 42, responder tags 44, and notification component 49 through communication links 48. Communication links 48 may be a variety of types of communication links, and may have varied or multiple links per communication link 48 shown. For example, communication links 48 may be hardwired and include a physical connection, or may be a wireless connection such as in RF communication. Wireless communication systems may be proprietary or pubic, licensed or unlicensed, and operate in the HF or UHF band. Typically, proprietary and licensed protocols are chosen to minimize interference with other RF emitting systems that operate in healthcare environments. Communication link 48 may include a cellular communication, WIFI or WiMax using the internet, or via any appropriate communication protocol or method as will be apparent to one of ordinary skill in the art upon reading the present disclosure.

Central system 46 includes central system processor 47. Central system processor 47 can control any work flows associated with the healthcare alert system 40 and process and store information and data associated with healthcare alert system 40. User interface 43 allows an administrator or other individual with access information stored in central system 46, run reports, change configuration setting on the system or perform any other desired administrative or other functions. User interface 43 may include input devices such as keyboards, touch sensitive devices, or other various display technologies.

Central system 46 can be configured to interact with healthcare alert modules 42 to receive alerts, receive responder information, such as the time a responder arrives at the healthcare alert module 42 and the time the responder leaves the healthcare alert module 42. It can automatically reset, control, receive information, and transmit information to healthcare alert modules 42.

Central system 46 can be configured to communicate with responder tags 44 through communication link 48. Communication link 48 may initially communicate with responder tags 44 to read factory written identification information from the RFID tag with responder tag 44 and store that identification information along identification information related specifically to the responder and entered into central system 46 through user interface 43. Communication link 48 may also be configured to write information to the IC chip on responder tag 44. Central system 46 can also control the RFID reader in a healthcare alert module 42 to write information to an RFID tag 32 in a responder tag 30 or perform any of the interactions described.

Healthcare alert modules 42 communicate with responder tags 44 through communication link 48. During the exchange, the healthcare alert module 42 obtains the RFID tag identification number to identify when an alert activation was acknowledged and who responded. The healthcare alert module 42 transmits the responder tag 44 RFID tag information to the central system 46 for processing and notification generation.

Central system 46 also communicates via communication link 48 with notification component 49. Notification component 49 may be any component or method for notifying of an alert from a healthcare alert module 42, notifying that a responder has responded to the alert or escalating the alert to a higher level. Notification component 49 may be a screen which displays a message, a computer or other electronic device capable of receiving an emailed message, a pager that receives a page, mobile device that receives an SMS text message, a fax machine, a light flashing at a particular location, such as a light above the door to a user's bedroom, or any other device that facilitates communication between central system 46 and notification component 49.

Central system processor 47 may be configured to do statistical reporting. For example, the central system processor 47 may track and calculate average time between activation of an alarm and arrival of a responder; average time between arrival of responder and departure of a responder; and average number of alerts responded to per responder. Central system processor 47 may also generate reports on the performance of a particular responder, and a report comparing responder performance. Reports generated by central system processor 47 can in some instances be transmitted to notification component 49.

Multiple healthcare alert modules 42 may be deployed to cover and support a healthcare environment. The circumstance of the deployment may require the use of routers or hubs to efficiently exchange information among the healthcare alert modules 42, responder tags 44, and the central system 46. Remote access systems such as desktop or laptop computers, tablet devices, or smart phones connect to the central system 46 through wired or wireless hubs to provide access, review, and download of activated alert information. Known techniques can be implemented to leverage hubs or routers to transfer information through the communication link 48

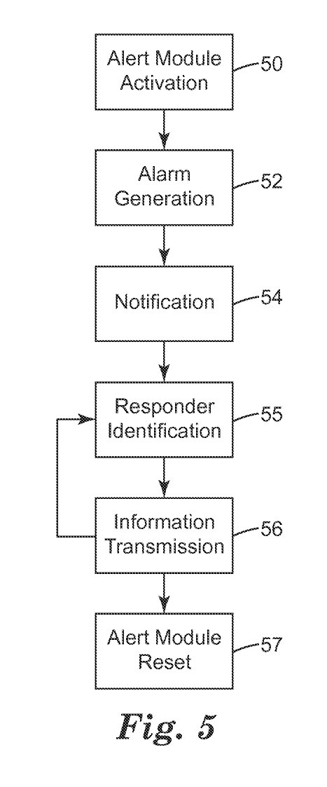

FIG. 5 shows a flow chart of an exemplary workflow associated with a healthcare alert module. While FIG. 5 shows particular steps in a particular order, in some instances, steps may be performed in a different order consistent with the present disclosure.

In step 50, a healthcare alert module is activated. The healthcare alert module may be activated by a user for a variety of reasons as described elsewhere, and by a variety of methods, depending on the particular configuration of the healthcare alert module. The healthcare alert module can transmit the information to the central system. The information regarding the alert transmitted to the central system can include identification information for the particular healthcare alert module, it may include identification information for the individual who is associated with the healthcare alert module or who is expected to have activated the alarm. Information regarding the time and the particular need associated with the alert may also be transmitted to the central system. In another configuration, the fact of an alert and the identification information of the healthcare alert module may be the only information transmitted to the central system, and the central system may then time stamp the receipt of the alert and look up stored information associated with the particular healthcare alert module.

In step 52, an alarm is then generated. In many instances, the alarm may be generated by the central system. The alarm may include more detail than the information received from the healthcare alert module associated with the alert. The alarm may include the user associated with the healthcare alert module, the responder expected to respond to the alert, the type of assistance requested, the time the alert was activated, the location of the healthcare alert module, or any other pertinent information. In another configuration, the alarm may be generated directly by the healthcare alert module and may be sent directly to a device, such as a light, or a light emitting diode (LED) display.

In step 54, a notification is sent. The notification may simply be the illumination of a particular light, or may be an email sent to a particular responder or a variety of potential responders with some of the information related to the alert as described above. In one configuration, the notification may be sent directly to responder's tag 30.

In 55, a responder to the notification is identified. This can be achieved by a responder presenting their responder tag to the RFID reader, and the reader reading information stored on the IC chip in the RFID tag in the responder tag, then transmitting that information to the central system in step 56. Steps 55 and 56 may be repeated several times. For example, a responder may present their tag to the RFID reader after initially arriving in response to an alert, and they may do so a second time upon completing any task or offering any assistance associated with the alert. Multiple responders responding to the alert may all present their responder tags to the RFID reader in the healthcare alert module. In some configurations, the RFID reader may be enabled to read information from multiple responder tags substantially simultaneously. The healthcare alert module may transmit information to the central system immediately upon receipt, at regularly scheduled intervals, or it may store information and later transmit all information associated with a single alert to the central system at one time or in one packet.

In step 57, the alert module is reset so that it is configured to trigger another alert. It may be reset by a responder, automatically by the system, or by a user. Information related to the alert module being reset can also be sent to the central system.

### Example 1

### Quality of Care

### Identification of Who Responded to an Alert and when

Quality of care within a healthcare environment is a metric of critical importance. The ability to identify when an activated alert was acknowledged by a responder and by which responder is a quantifiable metric to measure or ascertain the quality of care. Previous systems are unable to define this metric, particularly on a per-responder level, as a quantity that can be statistically analyzed. As outlined in FIG. 5, activation of the healthcare alert module as shown in step 50 trigger, pull cord, or sensor generates an alert or alarm as shown in step 52. Notification of the alert activation is then transmitted to a responder as shown in step 54. Notification occurs through visual and/or audible mechanisms such as flashing lights or the activation of a siren. In most applications, the alert notification would be transferred through a communication pathway, wired or wireless, from the healthcare alert module to the central system. Connected to the central system through routers and hubs would be remote access systems 61 (as shown in FIG. 4), which permit the display and review of captured alerts. The notification is represented on the user interface or display of the central system or remote access systems as a text, an interactive map of the healthcare environment with the alert identifying a room, zone, or region, or as a pop-up window on the display. Other methods to display notifications would be apparent of one of skill in the art. Once notification has occurred, the responder would travel to the room, zone, or region where the alert was activated. Upon arrival, the responder would approach the healthcare alert module and present their responder tag to the RFID reader as shown in step 55. The RFID reader would obtain the unique identification number of the responder tag through HF inductive coupling within a read range of less than twelve inches. The healthcare alert module alert or alarm would also be deactivated by the responder pressing the reset button as described in step 57. Prior to distribution of the responder tags with RFID tags installed, the RFID tag identification number would have been uploaded in the central system as being associated with a unique responder. The healthcare alert module would transfer the RFID tag information, the date and time, and its identification information to the central system 56. The responder presents their RFID tag to the healthcare alert module to record the total time required upon completion of responding to the alert. Information during each presentation of the RFID tag would be transferred, stored, and available for analysis from multiple healthcare alert modules to the central system:

TABLE 1

| | | | Date/ | |
|---|---|---|---|---|
| Healthcare | Date/ | Date/ | Time Alert | Responder |
| Alert | Time Alert | Time Alert | Response | RFID Tag |
| Module ID | Activated | Acknowledged | Complete | ID |
| 101 | 2012/03/27 | 2012/03/27 | 2012/03/27 | 00001 |
| | 07:35:10 | 07:38:23 | 07:48:12 | |
| 102 | 2012/03/27 | 2012/03/27 | 2012/03/27 | 00002 |
| | 07:40:30 | 07:41:31 | 07:42:07 | |
| 103 | 2012/03/27 | 2012/03/27 | 2012/03/27 | 00001 |
| | 08:17:15 | 08:18:10 | 08:35:43 | |
| 104 | 2012/03/27 | 2012/03/27 | 2012/03/27 | 00003 |
| | 09:48:25 | 09:53:55 | 09:59:59 | |

Table 1 represents a limited sample set of collected data. The list would be more expansive as additional alerts were activated, acknowledged, and responded to. The information would undergo statistical assessment within the central system in a reporting tool to obtain accurate performance metrics regarding when the alert was activated, when the alert was acknowledged, and who responded. Information contained within the Table is provided in one sample format and it would be apparent to one of skill in the art to identify other numeric or alphanumeric formats. The data in Table 1 shows that the responder associated with RFID tag ID 00002 took 1 minute and 1 second to acknowledge the alert activated by health care alert module 102. This information can be used as comparison against a predetermined healthcare environment quality of care metric such as a direction that all alerts will be responded to within 1 minute and 30 seconds from activated. Reporting tools are known in the industry and numerous options could be chosen to analyze and display the results in textual or graphical format. Analyzed results would be made available to the central system or the remote access system user interface or display and could be exported to review and proof of quality of care.

### Example 2

### Improvement of Care

### Alert Recurrence or Duration

Once a responder has presented their tag to the healthcare alert module, as outlined in FIG. 5, information associated with the module and the responder will be transmitted to the central system for processing. Transmission of data occurs over wireless UHF. Information would be transferred, stored, and available for analysis from multiple healthcare alert modules to the central system:

TABLE 2

| | | | Date/ | |
|---|---|---|---|---|
| Healthcare | Date/ | Date/ | Time Alert | Responder |
| Alert | Time Alert | Time Alert | Response | RFID Tag |
| Module ID | Activated | Acknowledged | Complete | ID |
| 101 | 2012/03/27 | 2012/03/27 | 2012/03/27 | 00001 |
| | 07:35:10 | 07:38:23 | 07:48:12 | |
| 101 | 2012/03/27 | 2012/03/27 | 2012/03/27 | 00001 |
| | 08:42:33 | 08:43:31 | 07:46:17 | |
| 101 | 2012/03/27 | 2012/03/27 | 2012/03/27 | 00001 |
| | 09:02:15 | 09:04:17 | 09:35:43 | |
| 101 | 2012/03/28 | 2012/03/28 | 2012/03/28 | 00001 |
| | 07:30:28 | 07:32:53 | 07:51:14 | |
| 101 | 2012/03/28 | 2012/03/28 | 2012/03/28 | 00001 |
| | 08:36:38 | 08:37:42 | 08:57:11 | |
| 101 | 2012/03/28 | 2012/03/28 | 2012/03/28 | 00001 |
| | 10:31:37 | 10:32:41 | 11:05:24 | |

Table 2 represents a limited sample set of collected data. The list would be more expansive as additional alerts were activated, acknowledged, and responded to. The information would undergo statistical assessment within the central system in a reporting tool to obtain accurate performance metrics regarding when the alert was activated, when the alert was acknowledged, and who responded. Information contained within the Table is provided in one sample format and it would be apparent to one of skill in the art to identify other numeric or alphanumeric formats. Analysis of Table 2 provides insight as to the frequency of alert or alarm activation and improvement or modification care for the individual that triggered the alert. As evident in Table 2, healthcare alert module 101 received, activated, acknowledged, and completed three alert activations on Mar. 27, 2012. The alerts were addressed by the same responder associated with RFID tag ID 00001. Patterns in the data are recognized for recurrent trends or warning signs that the individual activating the alert is not receiving the care to best address their condition. Table 2 shows that the same healthcare alert module was activated the preceding day, Mar. 28, 2012, at approximately the same time. Healthcare environment staff could modify or be proactive in care by sending a responder to the individual before an alert was triggered on Mar. 29, 2012. Also note that the amount of time to complete a response to the alert increased from March 27 to March 28 on the three instances the alert was activated. This information is used to document that a responder was actively responding to an alert and not available as a resource to others. The data can be used to manage healthcare environment staff more efficiently and/or to modify the care provided to the individual to improve their condition and reduce the quantity and duration of alerts.

### Example 3

### Accountability

### Awareness

Current systems are unable to accurately determine or document who responds to an alert or alarm. By monitoring who acknowledges and responds to an alert or alarm, healthcare environments such as nursing or assisted living homes are able to improve accountability awareness, document efficiencies, and adequately manage staffing resources to best meet the needs of the facility and regulated standards. Healthcare environment staff may be held accountable for proper or improper responses to alerts or alarms and appropriate action taken to commend or reprimand their behavior.

TABLE 3

| | | | Date/ | |
|---|---|---|---|---|
| Healthcare | Date/ | Date/ | Time Alert | Responder |
| Alert | Time Alert | Time Alert | Response | RFID Tag |
| Module ID | Activated | Acknowledged | Complete | ID |
| 101 | 2012/03/27 | 2012/03/27 | | 00001 |
| | 07:35:10 | 07:38:23 | | |
| 102 | 2012/03/27 | 2012/03/28 | 2012/03/28 | 00002 |
| | 07:40:30 | 01:25:31 | 01:28:07 | |
| 103 | 2012/03/27 | | | |
| | 08:17:15 | | | |

Table 3 represents a limited sample set of collected data. The list would be more expansive as additional alerts were activated, acknowledged, and responded to. The information would undergo statistical assessment within the central system in a reporting tool to obtain accurate performance metrics regarding when the alert was activated, when the alert was acknowledged, and who responded. Information contained within the Table is provided in one sample format and it would be apparent to one of skill in the art to identify other numeric or alphanumeric formats. As shown in Table 3, accountability and performance metrics of healthcare environment staff can be monitored from the mined data. Alert activation in healthcare alert module 101 was acknowledged by the responder associated with RFID tag ID 00001, but a response to the alert was not completed. An alert in healthcare alert module 102 was activated on March 27 at 07:40:30, but was not acknowledged until March 28 at 01:12:31 by a responder associated with RFID tag ID 00002. Lastly, healthcare alert module 103 activated an alarm on March 27 at 08:17:15, but no acknowledgement or completed response was received by a responder. Analysis of who was assigned to the healthcare alert module and why a response was not received can be performed.

### Example 4

### Benchmark Data

### Accreditation

Compilation, storage, access, and generation of reports based on the captured data associated with alert activation, acknowledgement, completed response, and responder provides benchmark statistics to improve a healthcare environments accreditation status. Reporting tools are known in the industry and numerous options could be chosen to analyze and display the results in textual or graphical format. Quality of care, improvement of care, and accountability awareness information is collated and transferred to accreditation entities as proof of compliance.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A radio frequency identification (RFID) healthcare alert module comprising:
an alert module comprising an activation component and an RFID reader;
wherein a user can activate an alert using the activation component;
wherein the RFID reader is configured to read identification information of a responder from an RFID tag associated with the responder and to transmit the identification information to a central system.

2. The RFID healthcare alert module of claim 1, wherein the alert module further transmits a time of response to the central system.

3. The RFID healthcare alert module of claim 1, wherein the alert module is mounted on a stationary object.

4. The RFID healthcare alert module of claim 1, wherein the RFID reader is configured to operate at a frequency within the range of 300 MHz to 3000 MHz.

5. The RFID healthcare alert module of claim 1, wherein the alert module is mounted to a door or a door frame.

6. The RFID healthcare alert module of claim 1, wherein the alert module further comprises at least one of a reset mechanism and a presence mechanism.

7. The RFID healthcare alert module of claim 1, wherein the RFID reader is configured to read passive RFID tags.

8. The RFID healthcare alert module of claim 1, wherein the activation component is a pull cord.

9. An RFID healthcare alert system comprising:
a plurality of alert modules, wherein each alert module comprises an activation component and an RFID reader;
wherein at least one of the RFID readers is configured to read identification information of a responder from an RFID tag associated with the responder, and to transmit the identification information to a central system;
wherein the central system is configured to associate a time stamp with the received identification information.

10. The RFID healthcare alert system of claim 9, wherein at least one of the alert modules is mounted to a stationary object.

11. The RFID healthcare alert system of claim 9, wherein the RFID readers are configured to read the identification information of the responder when the responder arrives at the location of the alert module and when the responder leaves the location of the alert module.

12. The RFID healthcare alert system of claim 11, wherein the central system is configured to calculate at least one of: average time between activation of an alarm and arrival of a responder; average time between arrival of responder and departure of a responder; and average number of alerts responded to per responder.

13. The RFID healthcare alert system of claim 9, wherein the central system is configured to generate notifications by at least one of: SMS message, email, page, fax, display, light or electronic sign.

14. The RFID healthcare alert system of claim 9, wherein the central system is configured to generate statistical reports related to the performance of responders.

15. The RFID healthcare alert system of claim 9, wherein the identification information is transmitted to the central system through a regional hub.

16. The RFID healthcare alert system of claim 9, wherein the identification information is a number associated with the responder in the central system.

17. A method of handling a healthcare alert, comprising:
receiving an activation of a alert module through an activation component;
generating an alarm corresponding to the activation of the alert module;
reading identification information from an RFID tag associated with at least one responder using an RFID reader; and
transmitting the identification information to a central system.

18. The method of claim 17, wherein the central system is configured to associate a time stamp with the received identification information.

19. The method of claim 17, further comprising reading identification information of the responder when the responder arrives at the location of the alert module and when the responder leaves the location of the alert module.

20. The method of claim 18, further comprising the central system calculating at least one of: average time between activation of an alarm and arrival of a responder; average time between arrival of responder and departure of a responder; and average number of alerts responded to per responder.

21. The method of claim 18, further comprising, generating statistical reports related to the performance of responders.

22. The method of claim 17, wherein the identification information is transmitted to the central system through a regional hub.

23. The method of claim 17, further comprising generating a notification by at least one of: SMS message, email, page, fax, display, light or electronic sign.
